(19) United States
(12) Patent Application Publication
(10) Pub. No.: US 2017/0151655 A1
(43) Pub. Date: Jun. 1, 2017

(54) Method of Installing a door protection plate and tool therefor

(71) Applicant: Triangle Brass Manufacturing Company, Inc., Oceanside, CA (US)

(72) Inventors: Jason W. Bennett, Carlsbad, CA (US); Jose A. Ramirez, Huntington Park, CA (US)

(73) Assignee: Triangle Brass Manufacturing Company, Inc., Oceanside, CA (US)

(21) Appl. No.: 15/330,751

(22) Filed: Nov. 2, 2016

Related U.S. Application Data
(60) Provisional application No. 62/386,415, filed on Dec. 1, 2015.

(51) Int. Cl. B25B 11/02; E06B 7/28

(52) U.S. Cl. CPC B25B 11/02; E06B 7/28

(57) ABSTRACT

A method of installing a substantially rectangle plate, and in particular a protection plate, to the face of a door, as well as a tool for use in practicing such method.

### CROSS REFERENCE TO RELATED APPLICATION

This invention claims the benefit of U.S. Provisional Application No. 62/386,415 filed Dec. 1, 2015, incorporated in full herein by reference.

### BACKGROUND OF THE INVENTION

This invention relates to door protection plates, and more particularly to a method of installing a protection plate to a door and a tool for implementing such method.

Rectangular plates, typically of metal such as brass, bronze, stainless steel or aluminum, are commonly affixed to doors to protect vulnerable surfaces of such doors against effects of abuse, particularly in commercial or public buildings. Such protection plates are installed on a door to cover a lower portion of the door's face, generally horizontally from near the door's left vertical edge to near its right vertical edge, and vertically from near the door's bottom edge to a height determined by the plate's purpose. As examples, a so-called “mop plate” may be approximately 6 inches or less in height for protecting the door against cleaning solution damage when cleaning the floor in the vicinity of the door; a so-called “kick plate” is typically approximately 7 to 16 inches in height for protecting the door from damage which may be incurred by forceful contact with agents such as shoes or boots; and a so-called “armor plate” may be approximately 17 to 48 inches in height for extended protection against most other types of abuse including contacts from mobile equipment.

Any of these protection plates may be affixed to the door by screw mounting. In such cases, the rectangular plate will include screw apertures equally spaced approximately 6 inches or less apart, near each edge of the plate. The installer positions such plate on the door's face, using the plate as a template to mark the door's face through the apertures, then removes the plate, drills screw holes at the markings, replaces the plate to the door, inserts screws through the plate apertures and into the screw holes to affix the plate to the door.

Alternatively, the plate may be affixed to the door by adhesive mounting. The back side of the plate may be covered with an adhesive, and the installer places the plate with the adhesive side to the door and urges the plate against the door to affix the plate. The adhesive may be covered with a removable liner, in which case the installer removes the liner to expose the adhesive before the plate is placed to the door.

The adhesive mounting technique may be implemented using a two-sided (or double-sided) adhesive tape, such as manufactured by 3M Corporation and by Avery Dennison Corporation. One or more strips of such tape may be affixed to the back side of the plate, the liner having been removed from one side of the tape; and the liner on the other side of the tape is removed during plate installation to expose the adhesive before placing the plate to the door.

Both the screw mounting and the adhesive mounting techniques are often used for affixing protection plates to doors that are already in place and installed in their buildings. Installation of a protection plate on such doors, with the plate having to be appropriately positioned near the bottom edge of the door, is a cumbersome process requiring the installer to crouch on the floor beside the door while manipulating the plate and its positioning on the door, a feat for which the installer is expected to exhibit agility, balance and coordination skills approaching those of an accomplished contortionist.

To make matters worse, in the case where the adhesive mounting technique is used, once contact is made between the plates's exposed adhesive and the door face, the plate is virtually instantly bonded to the door. Even a slightly skewed affixed plate (i.e., one where the vertical edges of the plate are not parallel to the vertical edges of the door) is detrimentally noticeable. If deemed unacceptable, the plate must be physically removed from the door, a task which usually damages both the plate and the door, so that the door will require refinishing before another attempt is made to affix another plate to the door.

### SUMMARY OF THE INVENTION

The foregoing difficulties and consequences thereof are significantly alleviated by use of the tool and method of the present invention for installing protection plates to doors.

Briefly described, one aspect of the present invention includes a method of installing a substantially rectangular plate to a door, comprising: providing a substantially rectangular plate having a front surface, a back surface and a bottom edge; providing a tool comprising a substantially rigid frame including a first elongate member and a second elongate member orthogonal to the first member; the second member including an elongate ridge therealong orthogonal to the first member; releasably securing the first member along a side edge of the door with the second member near a bottom edge of the door and the ridge of the second member extending along a face of the door; positioning the plate with the bottom edge of the plate upon the ridge of the second member and the plate's back surface toward the face of the door; affixing the plate to the face of the door while the back surface of the plate is placed to the face of the door; and releasing the first member from its securement and removing the tool from the door. For facilitating the frame's positioning during the securing step, the second member preferably includes a rearwardly angled portion therealong for being positioned under the bottom edge of the door.

After the plate positioning step, a preferred manner of practicing the present invention includes the step of pivoting the plate about its bottom edge positioned upon the ridge of the second member until the back surface of the plate is placed to the face of the door. Although the pivoting step may be utilized for placing the plate's back surface to the face of the door when the plate affixing step is implemented by screw mounting, such pivoting step is of particular utility for facilitating the placing of the plate's back surface to the face of the door when the affixing step is implemented by adhesive mounting. For example, when mounting a plate provided with at least one strip of double-sided adhesive tape affixed to the plate's back surface, each tape strip's removable liner would be removed to expose the adhesive before the plate pivoting step. At the end of the pivoting step, the plate's adhesive-bearing back surface will be placed to the door face while the plate's bottom edge is upon the second member's ridge orthogonal to the first member along the side edge of the door, so that the affixed plate's bottom edge will be orthogonal to the door's side edge and the plate's side edges will be parallel to the door's side edges.

A further aspect of the present invention includes the tool for practicing the above described method, and in particular for positioning a substantially rectangular plate to a door for affixation thereto. Such tool comprises: a substantially rigid frame including a first elongate member and a second elongate member orthogonal to the first member, the first member configured for being positioned along a side edge of the door, the second member including an elongate ridge therealong orthogonal to the first member and configured for extending along a face of the door when the first member is positioned along the side edge of the door; and a securing device cooperating with the frame for releasably securing the first member along the side edge of the door; whereby a bottom edge of the rectangular plate may be positioned along the ridge for facilitating positioning of the plate for affixation to the face of the door.

In the preferred embodiment of the tool, the first and second members are orthogonally joined at a juncture of an end of the first member and an end of the second member; and the second member is configured for positioning its ridge near a bottom edge of the door when the first member is positioned along the door's side edge with the juncture near the door's bottom edge. The second member preferably includes an angled portion configured for extending under the door when the first member is positioned along the door's side edge with the juncture near the door's bottom edge.

### BRIEF DESCRIPTION OF THE DRAWINGS

The novel features believed to be characteristic of the invention, together with further advantages thereof, will be better understood by the following description considered in connection with the accompanying drawings in which preferred embodiments of the invention are illustrated by way of example. It is to be understood, however, that the drawings are for the purpose of illustration and description only and are not intended as a definition of the limits of the invention.

FIG. 1 is an elevation view of a face of a door with a protection plate affixed thereto;

FIG. 2A is a front elevation view of an example of a protection plate for being affixed to the door as in FIG. 1;

FIG. 2B is a cross sectional view of the plate of FIG. 2A taken along the line 2B-2B, with thickness exaggerated for clarity;

FIG. 3A is a rear elevation view of another example of a protection plate for being affixed to the door as in FIG. 1;

FIG. 3B is a cross sectional view of the plate of FIG. 3A taken along the line 3B-3B, with thicknesses exaggerated for clarity;

FIG. 4A is a rear elevation view of yet another example of a protection plate for being affixed to the door as in FIG. 1;

FIG. 4B is a cross-sectional view of the plate of FIG. 4A taken along the line 4B-4B, with thicknesses exaggerated for clarity;

FIG. 5 is a front, elevation view of a frame of a preferred embodiment of a tool according to the present invention for practicing the present method of installing a rectangular protection plate to a door;

FIG. 6A is a side elevation view of a first bracket for being carried by the frame of FIG. 5;

FIG. 6B is a front elevation view of the bracket of FIG. 6A;

FIG. 7A is a side elevation view of a second bracket for being carried by the frame of FIG. 5;

FIG. 7B is a front elevation view of the bracket of FIG. 7A;

FIG. 8A is a side elevation view of a third bracket for being carried by the frame of FIG. 5;

FIG. 8B is a front elevation view of the bracket of FIG. 8A;

FIG. 9 is a side elevation view of a preferred embodiment of the tool of the present invention including the frame of FIG. 5 with the brackets of FIGS. 6-8 in exploded view;

FIG. 10 is an isometric view of the tool assembled according to FIG. 9;

FIG. 11 is a side elevation view of the tool of FIG. 10 secured along a side edge of the door;

FIG. 12 shows the side edge of the door and secured tool as in FIG. 11 (in reduced scale), further representing a protection plate being pivoted on the tool for being placed to the door;

FIG. 13 is a front elevation view of the tool secured to the door with the protection plate positioned on the tool and placed to the door for being affixed thereto; and

FIG. 14 is a block flow diagram illustrating a preferred embodiment of the method of installing a substantially rectangular plate to a door according to the present invention.

### DETAILED DESCRIPTION OF THE PREFERRED EMBODIMENTS

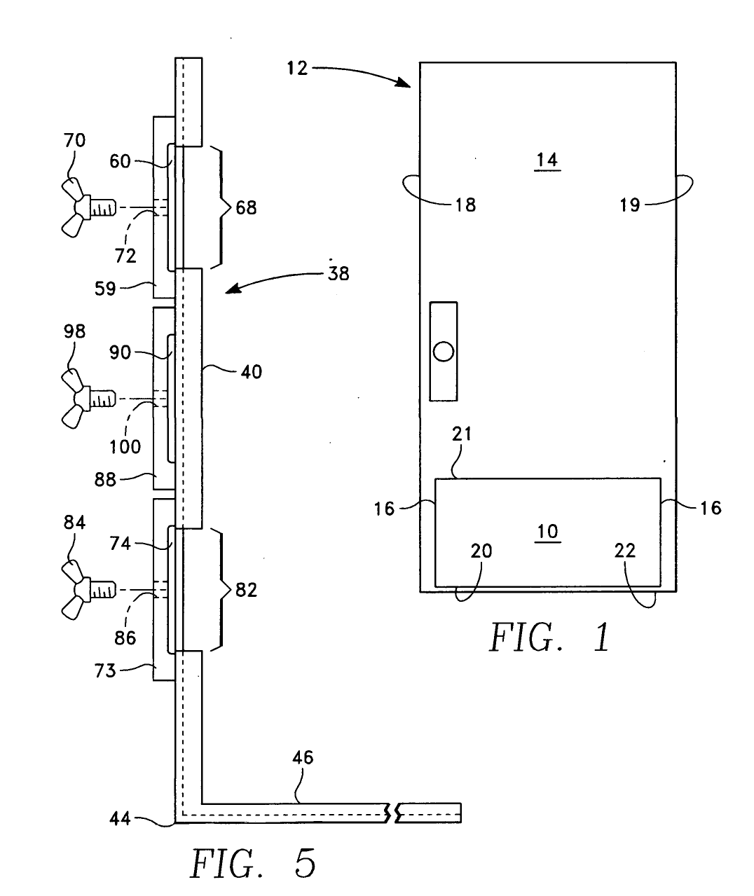

Turning to FIG. 1 there is illustrated an example of a substantially rectangular protection plate 10 affixed to a door 12. Such protection plates 10 may be of the so-called “mop plate”, “kick plate” or “armor plate” types described above and are commonly affixed to the face 14 of the door 12 with the plate's side edges 16 normally distanced approximately one inch from the door's side edges 18 and the plate's bottom edge 20 normally distanced approximately ¼ to ½ inch above the door's bottom edge 22, although other distances may be utilized as practical. Such plate 10 may be affixed to either the door's front surface or to the door's rear surface, and as used herein the word “face” denotes either surface.

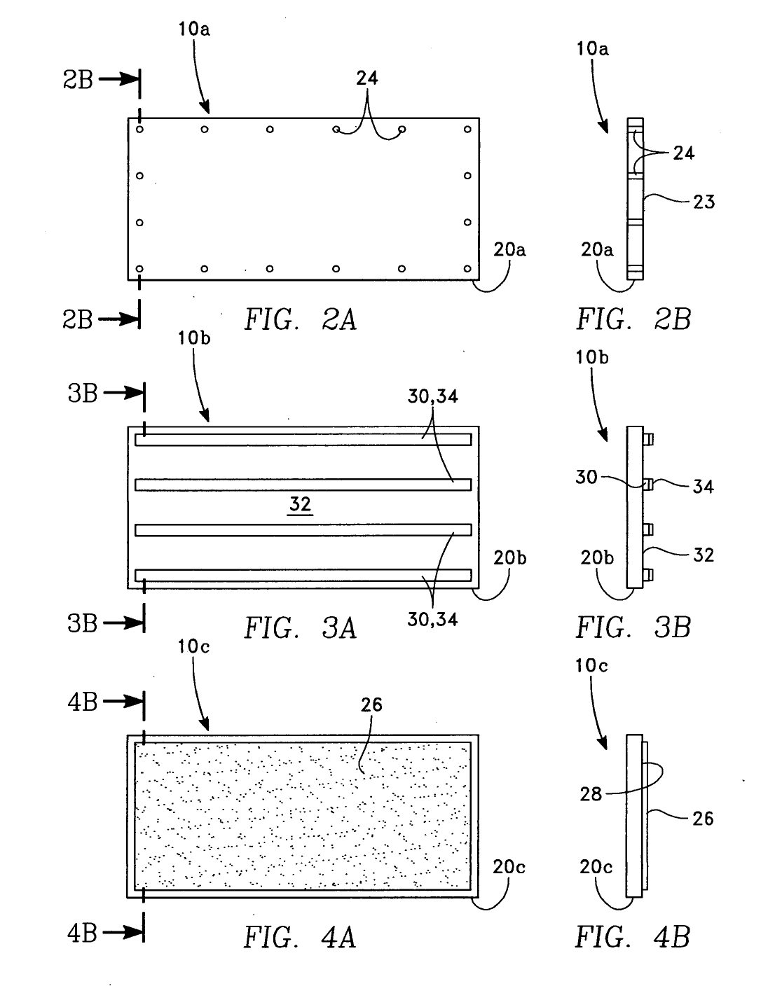

Examples of such protection plates 10 are represented in FIGS. 2, 3 and 4. The plate 10a of FIGS. 2A and 2B includes a plurality of spaced-apart screw apertures 24 therethrough along the plate's periphery for receiving screws (not shown), for implementing affixing the plate 10a to the door 12 by screw mounting.

Adhesive mounting for implementing affixing the plate to the door is represented in FIGS. 3 and 4. FIGS. 4A and 4B show an adhesive material 26 on the hack surface 28 of the plate 10c. FIGS. 3A and 3B represent the adhesive material as comprising at least one and preferably multiple strips of double-sided adhesive tape 30 on the back surface 32 of the plate 10b, each strip covered by a removable liner 34. When implementing affixing the plate to the door by adhesive mounting, the removable liner 34 is removed or peeled away from the tape to expose the adhesive of the tape 30. With respect to the adhesive material 26 on the plate 10c, such adhesive may be applied before affixation of the plate to the door, or such adhesive may be covered by a removable liner (similar to the liner 34 of the tape 30) which is removed or peeled away prior to affixation.

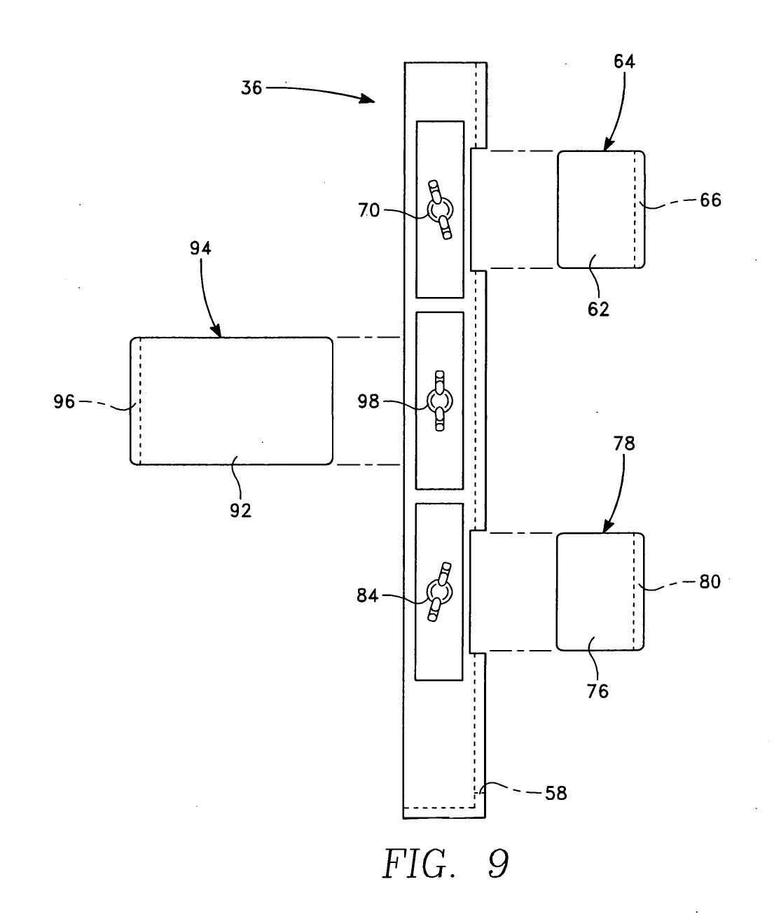

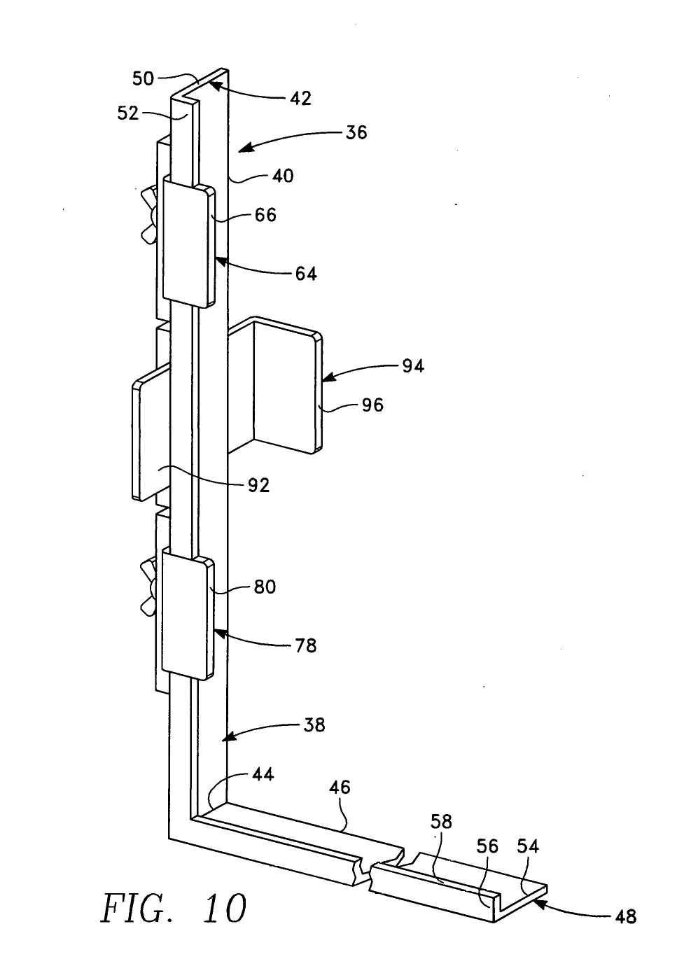

The preferred manner of practicing the method for installing the protection plate 10 to the door 14 according to the present invention, may best be described by first describing the tool for implementing such method, a preferred embodiment of such tool 36 being shown in FIGS. 9 and 10 with components thereof shown in FIGS. 5, 6, 7 and 8.

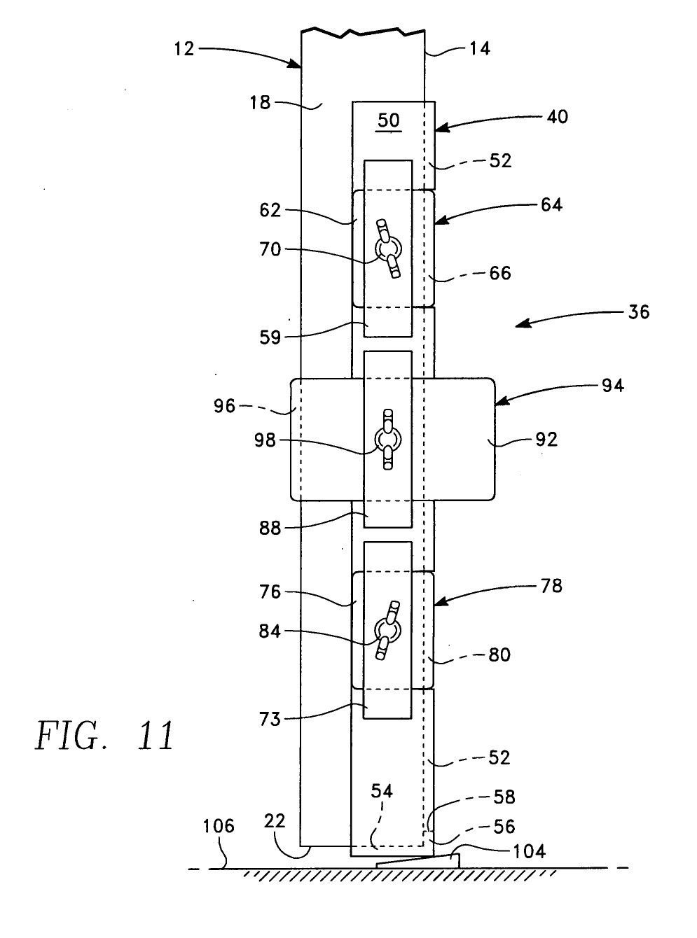

The tool 36 comprises a substantially rigid frame 38 which includes a first elongate member 40 of right angular cross section 42 orthogonally joined at a juncture 44 to a second elongate member 46 of right angular cross section 48. As best shown in FIG. 10, the first member 40 defining the right angular cross section 42 includes first member rearward leg 50 and sidewise leg 52, the first member 40 thereby being configured for being vertically positioned along the side edge 18 of the door 12 with the leg 50 against the door's side edge 18 and the leg 52 against the door's face 14 (see FIG. 11).

The second member 46 defining the right angular cross section 48 includes second member rearward leg 54 and upward leg 56 having an elongate ridge 58 therealong orthogonal to the first member 40 (in particular, orthogonal to the first member rearward leg 50). In this preferred embodiment, the second member 46 is configured such that its rearward leg 54 extends under the bottom edge 22 of the door when the first member 40 is positioned along the side edge 18 of the door 12 with the juncture 44 near the door's bottom edge 22. The second member upward leg 56 will extend along the face 14 of the door 12 with the ridge 58 horizontally extending along the face 14 when the first member 40 is vertically positioned against the vertical side edge 18 of the door 12.

The nominal distance of the horizontally disposed ridge 58 above the door's bottom edge 22 is determined by the height of the second member's upward leg 56, which height may vary depending upon the desired vertical positioning of a plate 10 to be affixed to the door 12.

The tool 36 of the present invention preferably includes of a securing device cooperating with the frame 38 for securing the frame 38 in its desired position to the door 12, which securing device is releasable to permit the tool 36 to be removed from the door to which the tool 36 is secured. An example of such releasable securing device includes the clamping structure described with reference to FIGS. 5-11.

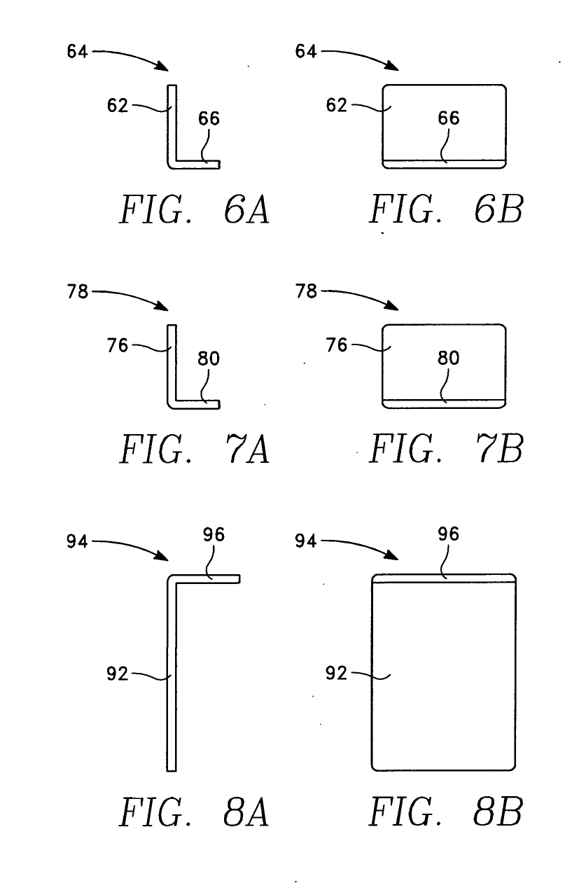

The first member 40 includes a first bracket holder 59 with a first vertically oriented slot 60 (FIG. 5) for receiving one leg 62 of a first bracket 64 (FIGS. 6A and 6B); while this bracket's other leg 66 extends through a first opening 68 in the first member's sidewise leg 52 for engaging the door face 14 when the tool 36 is applied to the door 12 (FIGS. 5 and 9-11). A first thumb screw 70 is threadedly inserted in threaded aperture 72 in the bracket holder 59 for causing the thumb screw's head to engage the leg 62 of the bracket 64.

Similarly, the first member 40 includes a second bracket holder 73 with a second vertically oriented slot 74 for receiving one leg 76 of a second bracket 78 (FIGS. 7a and 7b) while this bracket's other leg 80 extends through a second opening 82 in the first member's sidewise leg 52 for engaging the door face 14 when the tool 36 is applied to the door 12. A second thumb screw 84 is threadedly inserted in threaded aperture 86 in the bracket holder 73 for causing the thumb screw's head to engage the leg 76 of the bracket 78.

The first member 40 further includes a third bracket holder 88 with a third vertically oriented slot 90 between the other two slots 60 and 74, for receiving one leg 92 of a third bracket 94 (FIGS. 8A and 8B), such that this bracket's other leg 96 opposes the legs 66 and 80 of the other two brackets 64 and 78 as shown in FIGS. 9 and 10. A third thumb screw 98 is threadedly inserted in threaded aperture 100 in the bracket holder 88 to cause the thumb screw's head to engage the leg 92 of the bracket 94. The position of the leg 96 is thereby adjustable by adjustably sliding the leg 92 through the slot 90 while the first member 40 is positioned along the edge 18 of the door 12. The thumb screw 98 may be tightened to secure the bracket 94 with its leg 96 against the reverse surface 102 of the door 12 (see FIG. 11) while the other two brackets 64 and 78 are secured with their legs 66 and 80 against the face 14 of the door 12. In such manner, the first member 40 may be clamped along the side edge 18 of the door 12.

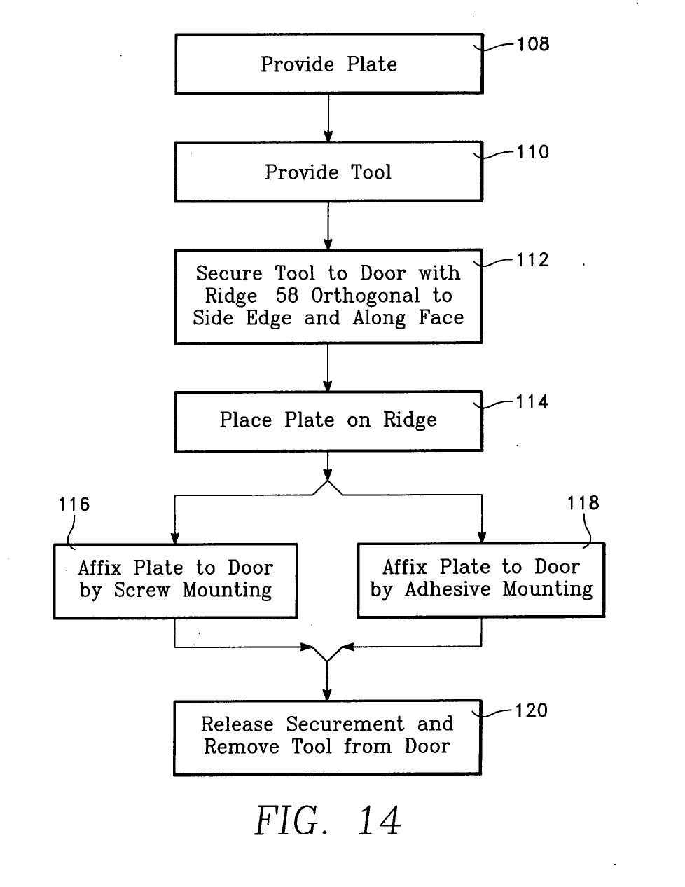

A preferred manner of using the tool 36, as well as a preferred manner of practicing the method of the present invention, are described with reference to FIGS. 10-13 and to the block flow diagram of FIG. 14.

Such method includes the steps of providing the substantially rectangular plate 10 (block 108 of FIG. 14), and providing the tool 36 (block 110), such plate 10 and tool 36 having been described above. Block 112 represents the step where the tool 36 is secured to the door 12 such that the ridge 58 of the tool frame's second member 46 is orthogonal to the door's side edge 18 and extends along the door's face 14, which step 112 is described in greater detail with reference to FIGS. 10-13.

The tool 36 is placed to the door 12 with the first elongate member 40 of the frame 38 positioned along the door's side edge 18. Specifically, the first member's rearward leg 50 is positioned along the door's side edge 18 while the first member's sidewise leg 52 is positioned along the door's face 14 (FIGS. 10, 11 and 13). At the same time, the frame's elongate second member 46 is placed such that an angled portion thereof (i.e. its rearward leg 54) extends under the door's bottom edge 22 while its upward leg 56 extends along the door's face 14. The juncture 44 is at or slightly below the door's bottom edge 22, determined by the deviation (if any) from perpendicularity of the door's bottom edge 22 from the door's side edge 18.

The first and second brackets 64, 78 are adjusted through the first member's slots 60, 74 and openings 68, 82 such that the inner surfaces of the brackets' second legs 66, 80 contact the door's face 14, and the thumb screws 70, 84 are tightened against the brackets' first legs 62, 76 to maintain such adjustments. Similarly, the third bracket 94 is adjusted through the first member's slot 90 such that the inner surface of this bracket's log 96 contacts the reverse surface 102 of the door 12, and the thumb screw 98 is tightened against the bracket's leg 92 to maintain such adjustment. In such manner the first member 40 is clampedly secured along the door's side edge 18. Such securement may be assisted by coating each bracket's inner contact surface with a non-slip substance. Securement may further be enhanced by upwardly supporting the frame 38, for example by inserting at least one wedge 104 between the floor 106 and the bottom of the frame 38 (FIGS. 11-13).

By secured positioning of the tool 36 to the door 12 as described, the ridge 58 along the tool's second member 42 is positioned along the door's face 14 near the door's bottom edge and orthogonal to the door's edge 18.

Continuing with block 114 of FIG. 14, the plate 10 is then placed on the ridge 58, with the plate's bottom edge 20 resting on the ridge 58 and the plate's back surface generally toward the face 14 of the door 12. The plate is preferably sidewise positioned so that it is centered along the width of the door; for example, the plate's width may be such that its side edges 16 may be distanced about one-inch from each vertical edge of the door 12.

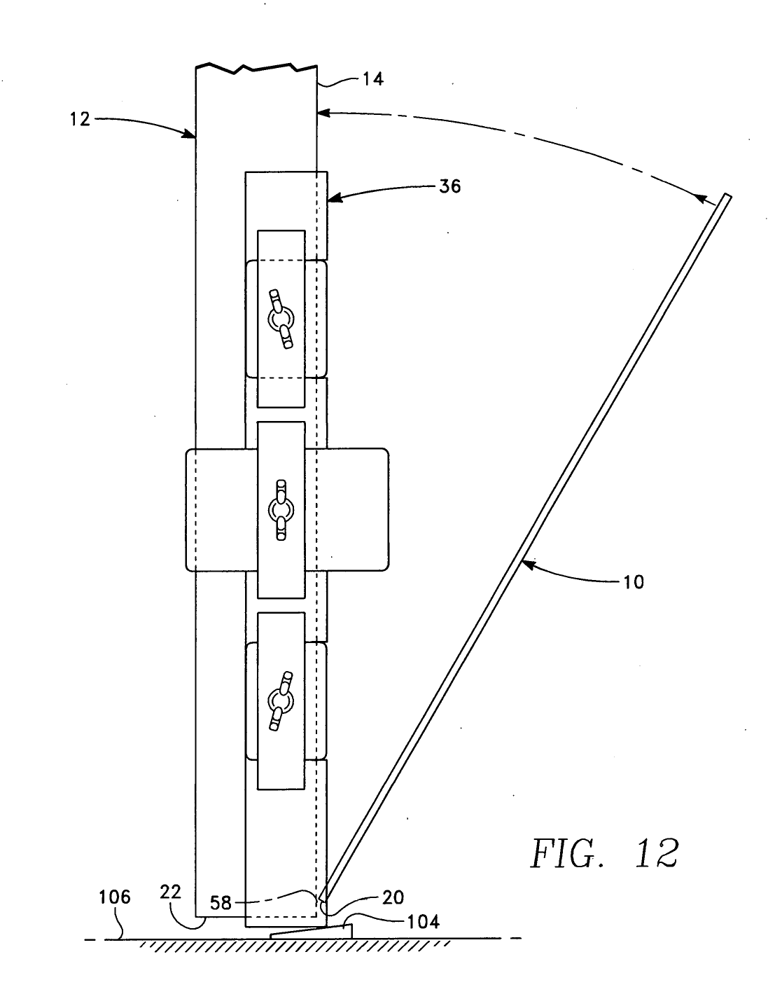

The plate 10 is then affixed to the face 14 of the door 12. If such affixation is to be implemented by screw mounting (block 116 of FIG. 14), the placement of the plate 10a containing screw apertures 24 (see FIGS. 2A and 2B) may be accomplished by placing such plate's back surface 23 directly against the door face 14 with the plate's bottom edge 20a on the ridge 58; or by placing the plate 10a with its bottom edge 20a on the ridge 58 and its back surface 23 toward the door face 14, then pivoting the plate 10a toward and against the door face 14 (see FIG. 12). In either case, while the plate 10a is so positioned against the door face 14, the installer places a mark on the door face 14 at the location of each aperture 24. The installer then removes the plate from the door face 14, drills screw holes in the door at each mark, replaces the plate to the door face, and then mounts the plate to the door face by inserting screws through the plate's apertures 24 and corresponding holes in the door.

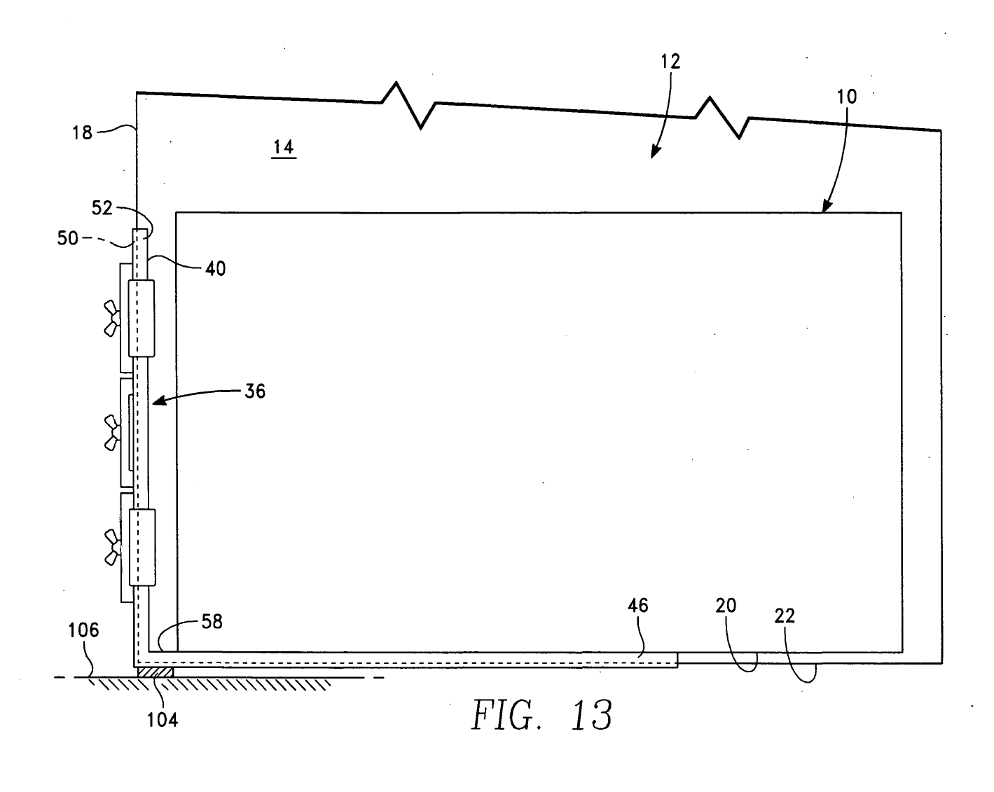

If the plate's affixation to the door face 14 is to be implemented by adhesive mounting (block 118 of FIG. 14), the plate including an adhesive on its back surface (see FIGS. 3A, 3B, 4A, 4B) is placed (preferably sidewise centered along the width of the door) with the plate's bottom edge 20b or 20c on the ridge 58 and the plate's back surface 32 or 28 toward the door face 14. Examples of such adhesive may be a coating 26 (FIGS. 4A, 4B), or strips of double-sided adhesive tape 30, 34, from which the removable liners have been removed. The installer then pivots the plate 10b or 10c about its bottom edge 20b or 20c positioned on the ridge 58 (FIG. 12) until the plate's adhesive treated back surface 32 or 28 is placed against the door face 14, thereby adhesive bonding the plate to the door face 14, as shown in FIG. 13. The installer may finish such adhesive affixation by further urging the plate against the door face, such as by applying a roller across the front surfaces of the plate while urging the roller toward the door face 14.

After the plate 10 has been affixed to the door face 14, the installer releases the frame's first member 40 from its securement along the door's side edge 18 (block 120 of FIG. 14), such as by untightening the thumb screw 98 and releasing the clamping action of the third bracket 94 with respect to the first and second brackets 64, 78, and by removing the wedge support 104 if used. The installer then removes the tool 36 from the door 12, resulting in the rectangular plate 10 having been affixed to the door face 14 with the plate's bottom edge 20 perpendicular to the left edge 18 of the door 12 (as shown in FIG. 1). Accordingly, the rectangular plate's top edge 21 is perpendicular as well to the left side edge 18 of the door 12, and the plate's side edges 16 are parallel to the left edge 18 of the door 12. Assuming that the door's right side edge 19 is parallel to the door's left side edge 18 the affixed plate's side edges 16 will also be parallel to the door's right side edge 19 and the plates bottom and top edges 20, 21 will also be perpendicular to the door's right side edge 19.

It should be realized that the embodiment of the invention as described above considered the door 12 as being hinged along its right side edge 19 (FIG. 1) with the tool 36 being applied along the door's left edge 18. If the door were hinged along its left side edge 18 instead, the structure of the tool 36 would of course be modified to accommodate its being placed along the door's right side edge 19. In either case, the door 12 would preferably be in an open position and prevented from moving when installing a plate to an installed door.

Thus, there has been described a preferred embodiment of a method of installing a substantially rectangular plate to the face of a door, as well as a preferred embodiment of a tool for use in practicing such method. Other embodiments of the present method and tool, and variations of the embodiments presented herein, may be developed without departing from the essential characteristics thereof. Accordingly, the invention should be limited only by scope of the claims listed below.

We claim:

1. A method of installing a substantially rectangular plate to a door, comprising:
providing a substantially rectangular plate having a front surface, a back surface and a bottom edge;
providing a tool comprising a substantially rigid frame including a first elongate member and a second elongate member orthogonal to said first member, said second member including an elongate ridge therealong orthogonal to said first member;
releasably securing said first member along a side edge of the door with said second member near a bottom edge of the door and said ridge of said second member extending along a face of the door;
positioning said plate with said bottom edge of said plate upon said ridge of said second member and said back surface toward the face of the door;
affixing said plate to the face of the door while said back surface of said plate is placed to the face of the door; and
releasing said first member from its securement and removing said tool from the door.

2. The method according to claim 1 wherein:
during the tool providing step, said second member includes therealong a rearwardly angled portion; and
during the securing step, said angled portion extends under the bottom edge of the door.

3. The method according to claim 1, wherein:
after the plate positioning step, pivoting said plate about said bottom edge of said plate positioned upon said ridge of said second member until said back surface of said plate is placed to the face of said door.

4. The method according to claim 1, wherein:
during the plate providing step, said plate includes spaced-apart screw apertures therethrough; and
the plate affixing step is implemented by screw mounting said plate through said screw apertures to the face of the door.

5. The method according to claim 3, wherein:
during the plate providing step, said plate includes spaced-apart screw apertures therethrough; and
the plate affixing step is implemented by screw mounting said plate through said screw apertures to the face of the door.

6. The method according to claim 3, wherein:
said plate is provided with an adhesive on said back surface.

7. The method according to claim 6, wherein:
during the plate affixing step, urging said plate against the face of the door.

8. The method according to claim 3, wherein:
said plate is provided with an adhesive on said back surface covered with a removable liner; and
before the plate pivoting step, removing said liner to expose said adhesive.

9. The method according to claim 8, wherein:
during the plate affixing step, urging said plate against the face of the door.

10. The method according to claim 8, wherein:
said adhesive comprises at least one strip of double-sided adhesive tape.

11. The method according to claim 9, wherein:
said adhesive comprises at least one strip of double-sided adhesive tape.

12. A tool for positioning a substantially rectangular plate to a door for affixation thereto, comprising:
a substantially rigid frame including a first elongate member and a second elongate member orthogonal to said first member, said first member configured for being positioned along a side edge of the door, said second member including an elongate ridge therealong orthogonal to said first member and configured for extending along a face of the door when said first member is positioned along the side edge of the door; and
a securing device cooperating with said frame for releasably securing said first member along the side edge of the door;
whereby a bottom edge of the rectangular plate may be positioned along said ridge for facilitating positioning of the plate for affixation to the face of the door.

13. The tool according to claim 12, wherein:
said first member and said second member are orthogonally joined at a juncture of an end of said first member and an end of said second member.

14. The tool according to claim 13, wherein:
said second member is configured for positioning said ridge near a bottom edge of the door when said first member is positioned along the side edge of the door with said juncture near the bottom edge of the door.

15. The tool according to claim 13, wherein:
said second member includes an angled portion configured for extending under the bottom edge of the door when said first member is positioned along the side edge of the door with said juncture near the bottom edge of the door.

16. The tool according to claim 14, wherein:
said second member includes an angled portion configured for extending under the bottom edge of the door when said first member is positioned along the side edge of the door with said juncture near the bottom edge of the door.
